(19) United States
(12) Patent Application Publication
(10) Pub. No.: US 2014/0173454 A1
(43) Pub. Date: Jun. 19, 2014

(54) METHOD AND SYSTEM FOR DESIGNING, DEPLOYING AND EXECUTING TRANSACTIONAL MULTI-PLATFORM MOBILE APPLICATIONS

(71) Applicant: LOGIC STUDIO, S.A., Panama City, PA (US)

(72) Inventor: Alex SANCHEZ, Panama City (PA)

(73) Assignee: LOGIC STUDIO, S.A., Panama City, PA (US)

(21) Appl. No.: 14/132,527

(22) Filed: Dec. 18, 2013

Related U.S. Application Data
(60) Provisional application No. 61/738,983, filed on Dec. 18, 2012.

(51) Int. Cl. G06F 3/0484

(52) U.S. Cl. CPC G06F 3/0484
USPC 715/747

(57) ABSTRACT

A method and apparatus for developing an application for utilization on a selected end user computing device may comprise modeling a screen display specific to the selected end user computing device, utilizing a development user computing device, by selecting an object for a user interface display or a control of a functionality of the application running on the selected user computing device, at run time, utilizing a prototyping display screen modeler during design time, which may be operating on the development user computing device or being accessed over a network by the development user computing device and constructing the model screen display specific to the selected end user computing device during design time, utilizing a user interface display on the development user device of a selection of controls or a selection of data sources displayed on the user interface display of the development user device.

### CROSS-REFERENCE

This application claims the benefit of U.S. Provisional Application No. 61/738,983, filed Dec. 18, 2012, entitled A METHOD AND SYSTEM FOR DESIGNING, DEPLOYING AND EXECUTING TRANSACTIONAL MULTIPLATFORM MOBILE APPLICATIONS, which application is incorporated herein by reference.

### BACKGROUND

The launching of a new product application, e.g., for utilization by users on user computing devices, such as mobile devices, e.g., smart phones, iPads, tablets, PDAs, such as Blackberrys, iPhones®, Androids®, and other portable points of access to a network, such as the Internet, due to many factors, such as different applicable operating systems and software source code languages, interfaces with specific types of hardware, and the like, have until now required skilled programmers, extensive time, prototyping and bug removal and the like before the product is ready for distribution to actual application end users in the marketplace. The present disclosed subject matter significantly simplifies this process, reduces time to market and thus, also, development costs and broadly increases the scope of the population of designers and developers capable of designing, developing and introducing such products from an application design concept to an actual product on the market.

### SUMMARY

A method and system/apparatus is disclosed for developing an application for utilization on a selected end user computing device platform which may comprise modeling a screen display specific to the selected end user computing device platform, utilizing a development user computing device platform, by selecting an object for at least one of a user interface display or a control of a functionality of the application running on the selected user computing device platform, at run time, utilizing a prototyping display screen modeler during design time; wherein the prototyping display screen modeler, during design time, is one of operating on the development user computing device platform or being accessed over a network by the development user computing device platform; and constructing the model screen display specific to the selected end user computing device platform during design time, utilizing a user interface display on the development user device platform of at least one of a selection of controls and a selection of data sources displayed on the user interface display of the development user device.

The method and apparatus may further comprise utilizing a user interface display on the development user device platform of a selection of permissions. the method and apparatus may further comprise editing the modeling screen display of the application specific to the selected end user computing device platform displayed on the prototyping display screen modeler of the development user device, during design time, includes selecting a control from the selection of controls displayed on the user interface display of the development user device for incorporation by the prototyping display screen modeler into the modeling screen display displayed on the prototyping display screen modeler. The method and apparatus may further comprise emulating the operation of the selected control displayed on the prototyping display screen of the development user computing device platform as the operation of the selected control would operate and be displayed on the selected end user computing device platform, which may further comprise emulating the operation of the selected control displayed on the prototyping display screen of the development user computing device platform through accessing at least one of the selected list of data sources.

The method and apparatus may further comprise wherein the selected list of controls includes at least a textbox control, a drop-down-list control and a button control or wherein the selected list of data sources includes at least one of a database, a web-service and remotely accessed data accessed through a communications feed. The method and apparatus may further comprise wherein the modeling screen display specific to the selected end user computing device platform, displayed during design time, comprises a WYSIWYG (what you see is what you get) representation of a corresponding screen display on the selected end user computing device platform at runtime. The selected end user computing device platform may comprise a mobile computing device platform.

Also disclosed is a machine readable medium storing instructions that, when executed by a computing device cause the computing device to perform a method which may comprise modeling a screen display specific to the selected end user computing device platform, utilizing a development user computing device platform, by selecting an object for at least one of a user interface display or a control of a functionality of the application running on the selected user computing device platform, at run time, utilizing a prototyping display screen modeler during design time; wherein the prototyping display screen modeler, during design time, is one of operating on the development user computing device platform or being accessed over a network by the development user computing device platform; and constructing the model screen display specific to the selected end user computing device platform during design time, utilizing a user interface display on the development user device platform of at least one of a selection of controls and a selection of data sources displayed on the user interface display of the development user device.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates by way of example, in block diagram form, a representative components of an application that may be developed and released for multiple platforms, according to aspects of embodiments of the disclosed subject matter;

FIG. 2 illustrates by way of example, in block diagram form, a representative membership model, according to aspects of embodiments of the disclosed subject matter;

FIG. 3 illustrates by way of example, in block diagram form, a representative process for creating a new application that may be developed and released for multiple platforms, according to aspects of embodiments of the disclosed subject matter;

FIG. 4 illustrates by way of example, in block diagram form, representative interactions between of a system for developing and releasing an application for multiple platforms, according to aspects of embodiments of the disclosed subject matter;

FIG. 5 illustrates by way of example, an application model, according to aspects of embodiments of the disclosed subject matter;

FIG. 6 illustrates by way of example, a representative screen editor, according to aspects of embodiments of the disclosed subject matter;

FIG. 7 illustrates by way of example, representative screen control properties, according to aspects of embodiments of the disclosed subject matter.

### DETAILED DESCRIPTION OF THE INVENTION

A system and method for designing, deploying and executing transactional multiplatform applications is disclosed. The system and method, e.g., can allow for the rapid design, data binding, and publishing of interfaces, e.g., in screens or pages provided, e.g., on a web-site by a web server, which can, e.g., allow for authenticated end-users to interact with those interfaces/screens on a particular mobile or desktop device platform. According to aspects of embodiments of the disclosed subject matter, e.g., a WYSIWYG (what you see is what you get) development platform for rapid development of, e.g., a mobile application (and, also, e.g., a functional prototype of the mobile application), as an example, in a markup language(s) for enabled devices. According to aspects of the disclosed subject matter, coding of the application, per se, is not required, which can, e.g., allow for the unification of mobile application development for multiple platforms, and additionally permit a simplified approach to building, e.g., transactional applications and web versions of corporate applications. The system and method may include, e.g., an Application Designer that can construct mobile user interfaces, an Application Server that can interpret the published designer metadata to generate a markup language(s) such as HTML, and an Emulator that can, e.g., tests the designed user interface(s) and execute them on a markup-language-enabled device.

The current proliferation of mobile devices and the increasing acceptance of these devices in corporate environments have generated a great demand for mobile application development for the enterprise. However, there previously had existed no unified development framework for native applications, e.g., that can be utilized for all devices of commercial interest. Moreover each device has its own operating system, language and APIs. Therefore the process of building a device-specific application has been quite time consuming and, therefore, also quite costly. For instance, a developer needs to know multiple platforms to achieve this task, including Android, iOS, Symbian, Blackberry, etc.

Many corporate applications, e.g., have been created for internal use only and generally employed for information retrieval or data entry. Hence, e.g., they may not require extensive use of graphics capabilities or high speed responses. According to aspects of embodiments of the disclosed subject matter, it is proposed that, for these applications, the development costs can be greatly reduced, e.g., by creating a web application instead of a native application, since the vast majority of midrange to high end mobile devices have a browser capable of interpreting high level markup languages such as HTML5.

Also, the development and maintenance of an application for each device have been time consuming, expensive and difficult to implement, especially for a company in which, e.g., corporate systems can require constant modifications, and the proliferation of devices and configurations, each with its own requirements, often requires many versions of the same application for each device. For instance, on the Apple® platform each version of an application must be distributed from an App Store and can be subject to waiting times for assessment and publication. In addition, it can be complicated to enforce upon corporate users a requirement to employ the same version of the application(s) of interest installed on their device. According to aspects of embodiments of the disclosed subject matter, it is proposed that, e.g., for enterprise customers a web application(s) aimed at a mobile device(s) can provide the most convenient solution.

With the adoption of the latest standard HTML version 5 and CSS3 by leading browsers, it is proposed that, e.g., a framework for agile development in JavaScript, such as JQuery, and a generalized use of frameworks that enable the display in mobile devices of a website in a user-friendly format, e.g., application developers can be enabled to create mobile versions of corporate web applications and make them available to all mobile devices that can interpret the particular markup language, such as, HTML5 or XAML. For instance, commercial frameworks such as JQuery Mobile, Dojo Mobile and Sencha UI can be utilized to simplify the creation of web applications, e.g., by giving a website the look and feel of a mobile device. These frameworks can then be utilized as tools for programmers. Other tools have been created based on these frameworks such as Codiqa, based on jQuery Mobile, which also can enable the prototyping of a web application. A virtual canvas can be utilized, e.g., where the user first drags controls to graphically create screens, and then retrieves the resulting HTML, which in turn, e.g., can then be utilized to serve as the basis for the development of an application.

According to aspects of the disclosed subject matter, it is proposed that with the proliferation of mobile platforms, and ongoing interest in unifying mobile application development, there currently several tools, such as, PhoneGap, Appcelerator and appMobi, etc. the utilization of which is proposed according to aspects of the disclosed subject matter. Generally speaking such tools would require deep programming knowledge, e.g., for users to code the application(s) from scratch in a specific language, such as Java or Javascript/HTML hybrid, in order to allow for compiling them into different native versions. These tools have generally been oriented towards developers and require coding to build the application of interest.

Publication number US2012/0036494A1 presents an example of a cross platform mobile application creation and management system. This patent has been implemented in the product iSites (http://www.isites.us), and describes how to build a platform that uses different data sources such as RSS feeds, Facebook®, Twitter®, Google+, etc. to generate a native application (a hybrid, actually) which displays such content as a portal. However, it does not allow for, e.g., transactional applications or web versions of corporate applications which can both be critical functionalities for business applications.

According to aspects of embodiments of the disclosed subject matter, a rapid application development (“RAD”) tool is proposed that can allow for rapid development, prototyping and release of, e.g., Web-based Apps, e.g., for business users. Also made possible can be the unification of mobile application development for multiple platforms, and building transactional applications and web versions of corporate applications.

Such a rapid application development (RAD) tool, according to aspects of the disclosed subject matter, can be, e.g., an application that allows a developer to create functional prototypes or applications much faster than building them from scratch, thus, favoring corporate automation with fast new product development instead of classic analysis-design-coding-testing. With the use of such a RAD tool, the idea, design and development for the application can be overlapped, which may, e.g., sometimes compromise some level of functionality, but in exchange of a much simpler and faster development time. Commonly a RAD tool can, e.g., provide a designer module that can allow a user to create user interfaces and configure logic and data binding, and a server that can, e.g., execute the generated prototype(s).

According to aspects of the disclosed subject matter, the proposed RAD platform may be utilized, e.g., to create a Mobile-Web application without resorting to coding as previously required, but, instead, e.g., configuring and linking components of the application screens as, e.g., textboxes, drop-down lists, etc. to, e.g., data sources and the like.

Accordingly, in contrast with the prior art, the disclosed subject matter can utilize a WYSIWYG (what you see is what you get) platform to prototype and run, e.g., mobile-web apps without coding the interface. Additionally the disclosed subject matter can, e.g., allow for the binding of controls of the screens to, e.g., such data sources such as databases, web services and others, and can also allow for publishing and execution of the application on a web server. It can also provide a mechanism(s) to restrict access to applications through user authentication. The disclosed subject matter can generate as an output(s) any markup language(s) such as HTML5 for browsers such as Google Chrome or Firefox, or XAML for Internet Explorer or Windows 8 clients that can then be interpreted by devices of interest.

The disclosed subject matter can be a RAD platform that allows users to obtain information from various corporate data sources such as web services, databases, RSS feeds and others, and can create a transactional web application, e.g., in a mobile friendly format. Such a system and method may then then assign access control to a user(s), given the user's role(s) or other specification, and, can publish the application, e.g., in an Application Server, where end users can access it from any browser within their device(s). It will be understood that this access may be by any web view or similar embedable technology that allows the application developer user to create a desired application. A benefit of an application server like Paradise is the ability to centralize requests generated from dispersed mobile computer devices that are used by application designer end users authorized by such access controls to access corporate data sources, and also this single point of contact can allow implementing such things as audits and security measures for an easy and secure extension of the corporate systems to the external devices

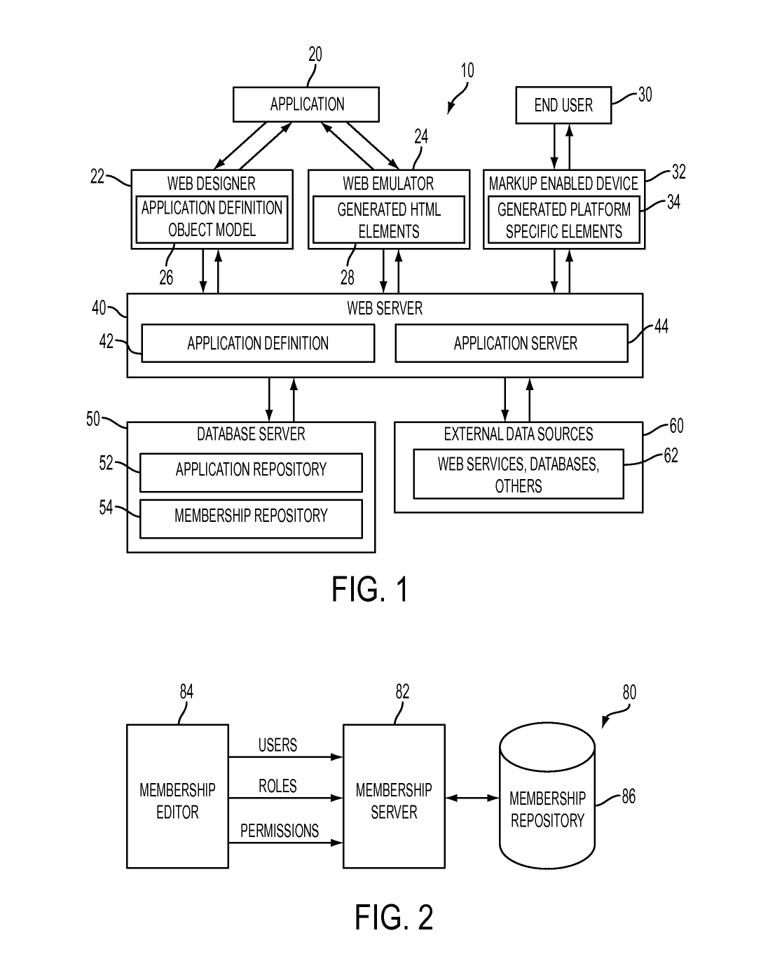

The disclosed system and can be, e.g., composed of the following modules: a) a designer, such as a web designer 26 to model, e.g., the interface(s) and behavior(s) of the application; b) a server, e.g., a web server 40, which may contain an application definition module 42 and an application server 44, which web-server 40 can, e.g., interpret, validate and execute any the application definition/model(s); c) a membership service 80 that can, e.g., allow for the creation and validation of user/developer 30 access to the web server 40 and any particular application(s); and, d) a memory/database server 50 for storing, e.g., application models and user/developer access information. FIG. 1, along with FIG. 2, illustrates, by way of example, in block diagram form, such modules making up a system and method 10 according to aspects of the disclosed subject matter.

FIG. 1 shows a block diagram 10 representing components of a system and method according to aspects of the disclosed subject matter. A designer, such as a web designer 22, which may include an application definition object model 26, can be supplied to, e.g., allow an administrator with administrative privileges to log in to the system 10 and monitor/administrate the creation of applications 20 by user/developers 30. An emulator, e.g., a web emulator can be utilized in creating the application 20 can include generated HTML elements, which may be utilized for prototyping or compiling a new mobile application, e.g., for transactional or informative purposes, which will be understood by those in the art to include such information as corporate information, office location, social network links, phone directory or transactional system information like mobile banking, statements, banking authorization, notifications or mobile services, such as for tourism, games, public services.

A server 40, including, e.g., an application definition/model 42 and an application server 44, can, e.g., also allow for the possibility of using as input, e.g., diagrams of different types, e.g., to be used for the system modeling, and then to, e.g., interpret such models in order to create applications that run these models. The application server 44, e.g., within the web server 40, can be utilized, e.g., for managing applications that are generated. Applications may be modeled/defined, e.g., by the application model/definition module 42, which can be, e.g., a set of classes that represent the displays, controls, data binding and application permissions.

When a request to run an application is made, e.g., either from an emulator, such as a web-emulator 24, including generated HTML elements 28 or an end-user device 30 of a user/developer, e.g., through a markup enabled user device 32, such as a computing device or a desktop device or a portable user device, including the use of, e.g., generated platform specific elements 34, the application server 44 can authenticate the end user device 30 of a user/developer, and/or the user/developer, and, as an example, any device displays utilized on the screens that make up the application 42. Additionally, the application server 44 can, e.g., communicate with the required data sources, e.g., which may be obtained from the database server 50 and/or external data sources 60, e.g., including web servers, databases, etc., and can then link them with, e.g., controls for the utilized screens display(s). Applications and membership information can also be stored, e.g., in an application repository memory 52 and/or a membership repository memory 54, within the database 52, 54 having a database server 50 for later retrieval.

As an application developer(s) creates a new application 20, the application developer can test the application 20, e.g., on a web emulator 24, which can, e.g., let the application developer run the application(s) 20 and, e.g., verify the behavior of the application 20 before publishing the application 20. Once an application 20 has been published, the end user 30 can access the application server 44 from her/his mobile device, e.g., 184, 188, 192 shown in FIG. 4, and run applications on which the end user device of a user/developer and/or the user/developer 30 has access authorization. The application developer can, e.g., utilizing the web designer, can allow creating, editing and deleting of an application(s), creating, editing and deleting users and roles, assigning user permission(s) and role(s) on a particular application, creating the display(s) of an application, the editing and configuration controls, data sources on a screen and allow for, as an example, an application to be run, e.g., in test mode from the web emulator 24., in test mode or review mode the user/developer can include feedback, e.g., in regard to the emulated application.

FIG. 2 illustrates, by way of example a block diagram 80 representing, e.g., a membership model 80 according to aspects of the disclosed subject matter. An editor, e.g., a membership/permissions editor 84 may be responsible for, e.g., administering the assignment of users, roles and permissions among users, e.g., designated with a role(s) and or other access to server applications, e.g., based upon membership. Membership data can be stored in a membership repository memory/database 86. The membership/permissions editor 84 can, e.g., allow for creating users and roles in the system 80 and the assignment of permissions for a role(s) or a user(s) of an application (20 as shown in FIG. 1). This membership/permissions editor 84 may, e.g., communicate with the membership repository memory/database 86, e.g., storing records of users and roles to, e.g., allow for the viewing and creation of an application(s) 20 by a requesting user(s), e.g., having a designated role(s), as well as assigning such a role(s) to a user(s) of an existing or under development application(s) (20 as shown in FIG. 1).

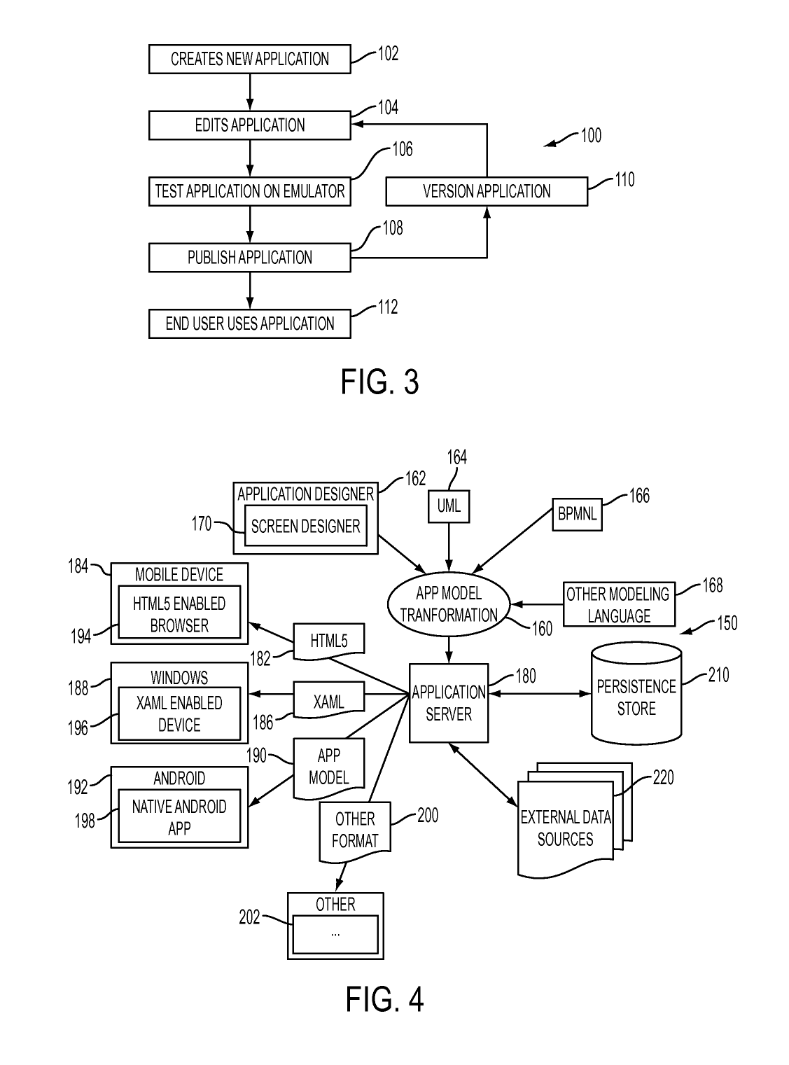

FIG. 3 shows a flow chart 100 representing, by way of example, steps for creating a new application 20 according to aspects of embodiments of the disclosed subject matter. An application designer/developer can log on to, e.g., the web designer 22 (FIG. 1) and choose new project, e.g., to create a new application, block 102 in FIG. 4. Assuming this is the start 102 of the new project an empty screen may be displayed, e.g., by the web emulator 24, e.g., adapted to utilize generated HTML elements, so the designer can then proceed to edit the blank screen, block 104, e.g., by adding, e.g., a control(s), a data source(s), or the like, and/or providing a user with a proper permission(s). As the user/application developer 30 is creating the application she/he may be testing it, e.g., using the emulator 24, block 106. Once the application is completed, the user/developer 30 can publish the application, block 108, making it available to all users who have permission to access it. After publishing, the application can be given a version designation, block 110, which may later be edited again in block 104, with any changes made to the particular version then republished in block 108. After completing the changes and the modified application is published the new version replaces the previous version. The application end user is given access to the latest version of the application in block 112.

FIG. 4 illustrates, in block diagram form, various elements of a system 150 for interacting with a user/developer 30 to construct a new application or to modify an existing application for the user/developer 30. The system 150 can provide, e.g., an application designer 162, which may contain, e.g., a screen designer 170, and may perform functions much like the web designer 22 and application model/definition object models 26 of FIG. 1. The application designer 162 may, e.g., allows an administrator to generate an application model to be used, e.g., to submit an application 20 to the end user/developer 30. The system 150 can allow for, e.g., the loading of models in various representations such as a unified modeling language (“UML”) 164, such as adopted by the Object Management Group (“OMG”), a standard body for model transformation languages, business process model and notation language (“BPMNL”) 166 or others 168 into the application model transformer module 160, and from them the application model transformation module 160 can, e.g., build a respective application model.

Once the application model in accordance with the particular model language 164, 166, 168 is received from the application model transformation module 160, by the application server 180, the application server 180 can then transform the application into, e.g., HTML5, XAML, native \Android, etc. and the transformed application can then also be saved, e.g., in a persistence memory/database 210, performing similar functions to the application depository database 52 of FIG. 1. When an application end user client requests the execution of some application, the application server 180 can, e.g., get the current application model from the persistence memory/database 210, run an appropriate screen to be sent to the application end user, and, if needed, obtain data from a data source, such as an external data source, databases, SOA/REST, RSS if needed on the current screen in the application 220. The application server 180 can then, e.g., convert the application into a specific markup language such as a hyper-text markup language (“HTML”), such as HTML5 182, extensible application markup language (“XAML”) 186, native Android application model 190 or other format(s) 200, e.g., respectively for a mobile device 184, such as, any of those noted above, with an HTML5 enabled browser 194, a windows operating system with an XAML enabled browser 196 an Android device with a native Android enabled browser 198 or others 202.

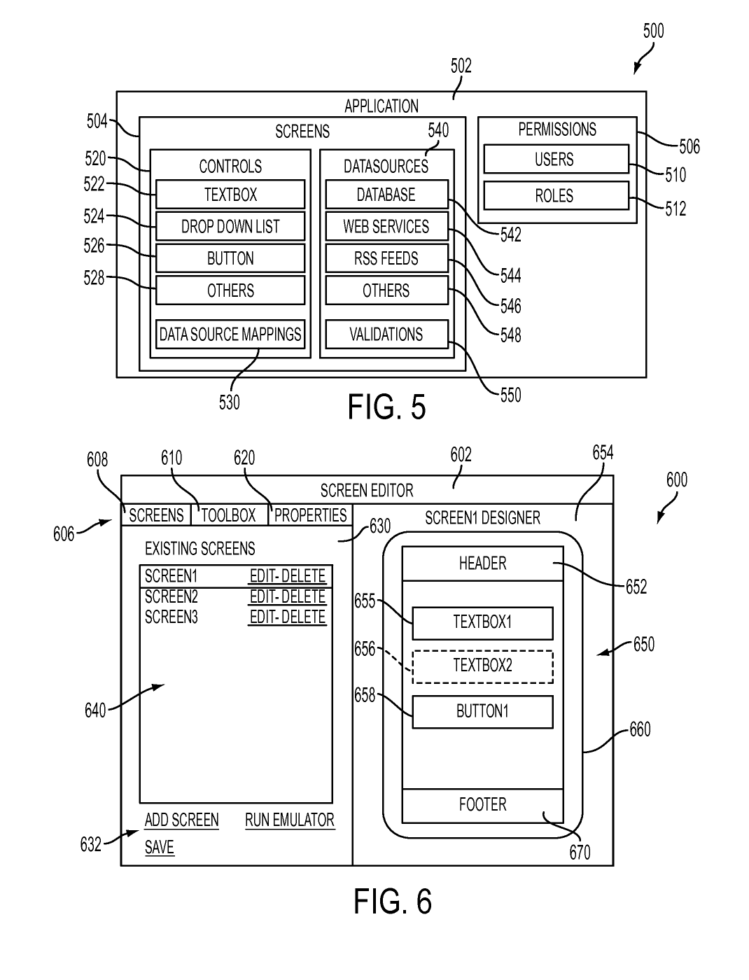

According to aspects of embodiments of the disclosed subject matter, and referring to FIG. 5, an object programming class model 500 can be created that, e.g., represents an application 502 as defined. The end user application designer (30 in FIG. 1) can be responsible for instantiating such a model. The object programming model 500 can, e.g., represent abstract object programming classes whose specific implementations can be utilized to, e.g., represent the components of an application. In the application model 500 of FIG. 5 permissions 506 can define a user(s) 510 with an authorization, which can, e.g., also be based on a role(s) 512 of the user 510, e.g., to allow the user(s) 510 access to different application projects 502. Screens 504 can be utilized to indicate a collection of several screens of which the application may be composed, such as a set of controls 520, which may also contain, e.g., a data source(s) mapping(s) 530, whereby, e.g., a screen can be given access to different data sources 540 to populate controls. The set of controls 520 may include, e.g., a textbox(es) 522, a drop-down list(s) 524, a button(s) 524 and other(s) 526. Datasources 540 may include a database(s) 542, a web service(s) 544, an RSS feed(s) 546 and other(s) 548. Screens 504 may include a validation(s) 550, e.g., to input control relating to user validations like textboxes that expect information to be completed by the end user or the input data needs to be in a range of values or in certain subset or format rules, like email, phone number, user name, password, etc.

As illustrated in FIG. 5 the application model 502 can be composed of a set of screens 504 and permissions 506. Each screen 504 can also be composed of, e.g., a set of controls 520 and a set of data sources 540. Each control 520 of a screen can, e.g., extend to a generic control model, which may define, e.g., a set of general attributes to all controls 520 that are useable by the designer/modeler (162 in FIG. 4). A set of interfaces that must be implemented by the application can also be used to model the behavior of a control(s) 520 at runtime, e.g., a textbox 522, dropdown list 524, button 526 and other(s) 528.

Each specific implementation can then be utilized to, e.g., add a respective attribute(s) for the correct display and execution of control, e.g., the control of the type “Textbox” 522 can add the attribute “Text”, and the control of type “Drop Down List” can add, e.g., the attribute a selection list, e./g., with “origin of elements in the list” as a specific attribute(s).

As an example, when a control 520 is being displayed at design time, such display 650 can be utilized this to display a list of attributes, e.g., that can allow the user/application developer 30 to configure the display and behavior of the control which will be seen and used by the end user at runtime. Validation(s) 550 can be included and utilized, e.g., as generic properties of a control(s) 520. A control(s) 520 can make use of a set of existing and common validations for all controls, such as validation of whether or not a given control is required, which data type and/or range of values can be accepted, etc. A control can extend the required validation(s) as needed for a specific control.

Data sources, e.g., 50, 60 in FIG. 1 and 540 in FIG. 5 can be utilized to obtain data from a particular source and expose the data and/or source(s) to control(s). The application server 180 can be utilized to orchestrate the execution of data sources, e.g., 50, 60 as appropriate. The data source, e.g., 50, 60, 540 can also represent an extensible model. In the same way as with the controls 520, the data sources, e.g., 50, 60, 540 can be defined by a presentation model at design time and expose functionality to get data from the appropriate source(s) at runtime. At design time a selected/designated data source 50, 60, 540 can provides a user/application designer the ability to configure the attributes of the particular data source(s) 50, 60, 540 and any visual element that represents it when added to a screen. Once configured, a data source 50, 60, 540 can be utilized, e.g., to make a make a mapping 530 between the information presented and existing controls in the application. A data source 50, 60, 540 may require, e.g., input parameters, such as to map the value of a specific control or a default value to the parameter. Once this is executed and the resulting data is obtained, the application can then map it to the control value(s).

The application designer/modeler 500 can save the application under development at any time, e.g., utilizing the design command option save from the list 632 on the screen editor panel 602 of FIG. 6. The application 20 can be stored in the application repository 52, e.g., using the application server 44. Each application 20 which is created can be so stored, e.g., in an object model that can model the screens, controls and existing data sources. An advantage of this application storage can be that an administrator user can decide whether this application will be available or not for an application end user by accepting or not accepting it for being published. At the time a user/application designer decides to publish an application; it can be, as noted above, given a version number and exposed to application end users. The administrator can use this application and/or make changes, keeping the online published version while modifications are in progress, e.g., being made by the user/application designer/developer. Once finished with such modifications, a new version can be published, replacing the previous version of the application.

As can be seen, the application designer/modeler of FIG. 5 and screen editor of FIG. 6 can allow the user/application developer 30 to run the application as it is being developed in the application emulator 24. When the “Run Emulator” command option is selected from the list 632 on the screen editor/designer 600, the application 20 can be thereby stored, e.g., in the application storage repository 52, e.g., by the server 44 and it can then be run as it will be and is so published. This can allow the user/application designer to verify the correct functioning of the modeled application before publication. Also feedback can be given, e.g., though the emulator, such that, e.g., external users, like end customers or testers can provide the feedback to interact with the application.

FIG. 6 illustrates as an example, a representation of an application screen designer/editor 600. FIG. 6 shows a screen editor panel 602 which can include, e.g., a left panel 630, which can present options for configuring application components, e.g., screens, using a screen panel tab 608, a toolbox tab 610 and properties, using a properties tab 620. A right panel 650 can display a screen designer, such as a screen 1 designer 654. An end user application designer can utilize the screen 1 designer 654 to visualize an application 20 being developed. FIG. 6 illustrates that within the screen editor prototype. The left panel shows that the several tabs 608, 610 and 620 can be selected, where selection of the screens tab 608, as illustrated, can display a list 640 of screens that have been selected or can be selected, e.g., to include in the application currently under development. Selecting the toolbox tab 610 can present a list of visual and non-visual controls that can, e.g., be composed, e.g., on a selected screen. Selecting the properties tab can display a panel showing, e.g., specific properties of a selected control(s).

On the right panel 654, e.g., a screen 1 designer can be displayed, e.g., when the screen 1 list item is selected in the panel 640. In the emulated display portion 660 in the right panel side 650 can be displayed, e.g., a WYSIWYG application designer emulation of an application screen 660 that can, e.g., represent the display 660, e.g., of a target user device, which can, e.g., by displaying a possible application screen display emulation can be utilized as a canvas where, e.g., screen features, e.g., a header 652, textbox 1 655, textbox 2 656, button 1 658 and footer 670 can be added, modified or removed on the selected screen emulation 660. At the bottom of the left panel side 630 are illustrated representative design command options 632, e.g., that can be provided to save the application, add a new screen and/or pre-visualization of the current application under development in the mobile device “looks-like emulator” 650 with the emulated mobile device display 660. As illustrated, the screens panel 640, if selected, can allow the user/application developer to add, remove and select a screen(s) to be edited, e.g., utilizing the screen designer panel side 654. Using the toolbox tab to select a toolbox panel the user/application designer can add controls in the screen designer application display WYSIWIG, and using the properties panel tab 620 the user/application developer can edit the properties of a screen 660 or control 658 selected with the screen designer/editor 600.

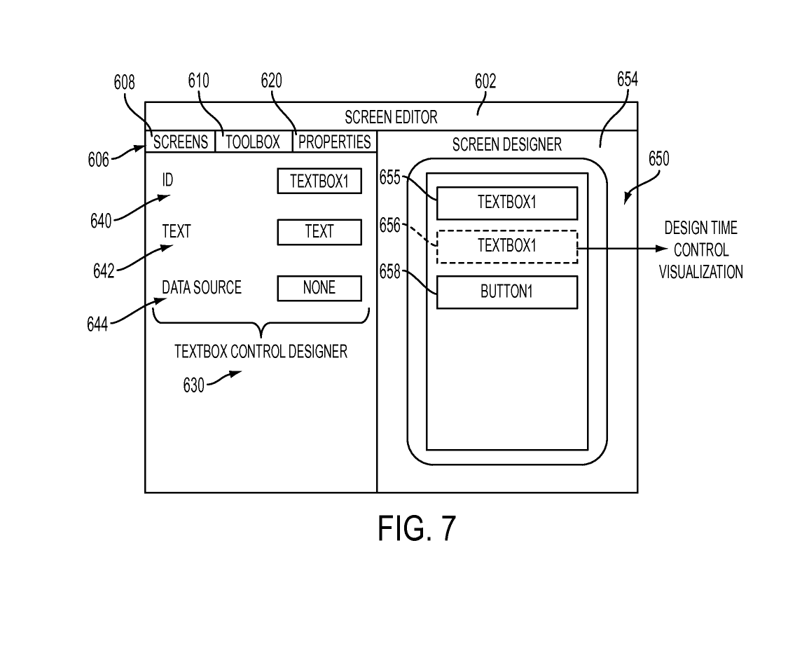

Each component of the system 10 when modeling/developing an application 20 can have certain characteristics, e.g., associated with design time and with runtime. To address the design time, the design components can be utilized, e.g., to expose an attribute(s) of a component(s) that can then be viewed and edited in the designer/editor 600. Additionally, control of design time can also be displayed by the designer/editor 600, e.g., as shown in FIG. 7. FIG. 7 as an example illustrates control properties that can be emulated and edited in the designer/editor 600 when the properties panel tab 620 is selected. As an example, in the illustration of FIG. 7, where the control “Textbox1” has been selected, it is presented in the WYSIWYG screen designer device display screen emulator 650 on the right panel 654. Thereby, the editor/application designer 20 can be allowed, e.g., to modify properties and a display can be created that allows user/application designers/editors to see the control in the emulated screen display 650, which can appear just as the application appears on the user device running the application at runtime.

A modeled application can be considered to consist of, e.g., a collection of controls 520 displayed on at least one application screen 660 and specific access permission rights 506 to the application, e.g., by defined a user(s) 510 having a defined role(s) 512. In turn, each application screen 660 can be composed of control(s) 520, e.g., for editing and display of data. These controls 520 can be utilized, e.g., to both obtain and send information to other objects defined on the display 660 which can, e.g., communicate with various data sources such as the application storage repository 52 or membership storage repository 54 of the database server 50, or web services, databases and others 62 of the external data sources 60, or the other listed data sources 540, such as database(s) 542, web services 544, RSS feeds 546, and others 548 as discussed above.

Once published the application 20 can be made available to the end user application user. Using a hybrid native client or accessing the application server 44 from a user computing device, e.g., a mobile device, the application end user can be presented with an authentication screen. This authentication screen may be dictated by and have a form factor consistent with the end user device, e.g., showing a consistent display. Once authenticated, the application end user can then be presented with a list of applications of which the application end user has authorization to use, either by user identification or role. When an application is selected, the server 44 can, e.g., load the model of the application from the application repository storage 52, verify that the display should be well rendered for the client, run the data sources (if any), generate the visual control(s) to be displayed on the screen, assign default or specified values in the mapping of the data source to control(s) (if any) and presents the user interface, e.g., according to the system and process illustrated in FIG. 4.

According to aspects of embodiments of the disclosed subject matter, design time can begin when an application is being modeled by the user/application designer/developer, e.g., utilizing the application designer/editor 500, 600 illustrated in FIGS. 5 and 6. Execution time can be considered to be when a designed or under development application is being executed, e.g., in the computing device of an application end user. A styles editor (not shown) can allow for the creation, editing, and removing cascading style sheet (“CSS”) style sheet styles that can be used in the screens at runtime. The style sheet files can have a set of classes already defined, and the user may edit these classes to customize the style of presentation of the application. These styles can then be stored in the persistence storage 210 by the application server 180 and can then be exposed to applications in order to reference them.

The application modeler/editor 500 of FIG. 5 can allow the application designer/developer user 30 to check in, check out and/or modify applications. This module 500 can define a first interface where the application designer/developer user can view existing applications and choose to edit or delete or modify any of the existing ones, or create a new one. After selecting the application to edit or modify the user can enter the screens editor module 600 of FIG. 6 and can, e.g., display a panel 650 listing existing screens of this application and allowing the application designer/developer user to edit, create new, or delete existing screens. When editing a screen, by selecting the toolbox tab 610 the screen editor 602 can be used to present the panel (not shown) containing the list of visual and non-visual controls that can be added to the screen. A screen editor display, similar to 650 in FIG. 6 can be utilized to present the project's screen, where the application designer/developer user can add, configure and delete controls. Also included, as illustrated in FIG. 7, can be a panel properties panel 640 that shows the properties of the selected controls in the screen modeler/editor, where the application designer/developer user can assign attribute values e.g., test input 642 and data source designation 644, that, e.g., can specify how the selected component will be displayed and how it will behave.

It will be understood by those skilled in the art that a method and apparatus is disclosed for developing an application for utilization on a selected end user computing device platform which may comprise modeling a screen display specific to the selected end user computing device platform, utilizing a development user computing device platform, by selecting an object for at least one of a user interface display or a control of a functionality of the application running on the selected user computing device platform, at run time, utilizing a prototyping display screen modeler during design time; wherein the prototyping display screen modeler, during design time, is one of operating on the development user computing device platform or being accessed over a network by the development user computing device platform; and constructing the model screen display specific to the selected end user computing device platform during design time, utilizing a user interface display on the development user device platform of at least one of a selection of controls and a selection of data sources displayed on the user interface display of the development user device.

The method and apparatus may further comprise utilizing a user interface display on the development user device platform of a selection of permissions. the method and apparatus may further comprise editing the modeling screen display of the application specific to the selected end user computing device platform displayed on the prototyping display screen modeler of the development user device, during design time, includes selecting a control from the selection of controls displayed on the user interface display of the development user device for incorporation by the prototyping display screen modeler into the modeling screen display displayed on the prototyping display screen modeler. The method and apparatus may further comprise emulating the operation of the selected control displayed on the prototyping display screen of the development user computing device platform as the operation of the selected control would operate and be displayed on the selected end user computing device platform, which may further comprise emulating the operation of the selected control displayed on the prototyping display screen of the development user computing device platform through accessing at least one of the selected list of data sources.

The method and apparatus may further comprise wherein the selected list of controls includes at least a textbox control, a drop-down-list control and a button control or wherein the selected list of data sources includes at least one of a database, a web-service and remotely accessed data accessed through a communications feed. The method and apparatus may further comprise wherein the modeling screen display specific to the selected end user computing device platform, displayed during design time, comprises a WYSIWYG representation of a corresponding screen display on the selected end user computing device platform at runtime. The selected end user computing device platform may comprise a mobile computing device platform.

Also disclosed is a machine readable medium storing instructions that, when executed by a computing device cause the computing device to perform a method which may comprise modeling a screen display specific to the selected end user computing device platform, utilizing a development user computing device platform, by selecting an object for at least one of a user interface display or a control of a functionality of the application running on the selected user computing device platform, at run time, utilizing a prototyping display screen modeler during design time; wherein the prototyping display screen modeler, during design time, is one of operating on the development user computing device platform or being accessed over a network by the development user computing device platform; and constructing the model screen display specific to the selected end user computing device platform during design time, utilizing a user interface display on the development user device platform of at least one of a selection of controls and a selection of data sources displayed on the user interface display of the development user device.

While preferred embodiments of the disclosed subject matter have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for developing an application for utilization on a selected end user computing device platform comprising:
modeling a screen display specific to the selected end user computing device platform, utilizing a development user computing device platform, by selecting an object for at least one of a user interface display or a control of a functionality of the application running on the selected user computing device platform, at run time, utilizing a prototyping display screen modeler during design time;
wherein the prototyping display screen modeler, during design time, is one of operating on the development user computing device platform or being accessed over a network by the development user computing device platform; and
constructing the model screen display specific to the selected end user computing device platform during design time, utilizing a user interface display on the development user device platform of at least one of a selection of controls and a selection of data sources displayed on the user interface display of the development user device.

2. The method of claim 1 further comprising:
utilizing a user interface display on the development user device platform of a selection of permissions.

3. The method of claim 1 further comprising:
editing the modeling screen display of the application specific to the selected end user computing device platform displayed on the prototyping display screen modeler of the development user device, during design time, includes selecting a control from the selection of controls displayed on the user interface display of the development user device for incorporation by the prototyping display screen modeler into the modeling screen display displayed on the prototyping display screen modeler.

4. The method of claim 3 further comprising:
emulating the operation of the selected control displayed on the prototyping display screen of the development user computing device platform as the operation of the selected control would operate and be displayed on the selected end user computing device platform.

5. The method of claim 4 further comprising:
emulating the operation of the selected control displayed on the prototyping display screen of the development user computing device platform as the operation of the selected control would operate and be displayed on the selected end user computing device platform through accessing at least one of the selected list of data sources.

6. The method of claim 4 wherein the selected list of controls includes at least a textbox control, a drop-down-list control and a button control.

7. The method of claim 5 wherein the selected list of data sources includes at least one of a database, a web-service and rich site summary (“RSS”).

8. The method of claim 1 wherein the modeling screen display specific to the selected end user computing device platform, displayed during design time, comprises a WYSIWYG representation of a corresponding screen display on the selected end user computing device platform at runtime.

9. The method of claim 1 wherein the selected end user computing device platform comprises a mobile computing device platform.

10. A system for developing an application for utilization on a selected end user computing device platform comprising:
a screen modeler configured to model a screen display specific to the selected end user computing device platform, utilizing a development user computing device platform, by selecting an object for at least one of a user interface display or a control of a functionality of the application running on the selected user computing device platform, at run time, utilizing a prototyping display screen modeler during design time;
wherein the prototyping display screen modeler, during design time, is one of operating on the development user computing device platform or being accessed over a network by the development user computing device platform; and
the screen modeler configured to construct the model screen display specific to the selected end user computing device platform during design time, utilizing a user interface display on the development user device platform of at least one of a selection of controls and a selection of data sources displayed on the user interface display of the development user device.

11. The system of claim 10 further comprising:
the screen modeler configured to utilize a user interface display on the development user computing device platform of a selection of permissions.

12. The system of claim 10 further comprising:
the screen modeler configured to edit the modeling screen display of the application specific to the selected end user computing device platform displayed on the prototyping display screen modeler of the development user device, during design time, by selecting a control from the selection of controls displayed on the user interface display of the development user device for incorporation by the prototyping display screen modeler into the modeling screen display displayed on the prototyping display screen modeler.

13. The system of claim 12 further comprising:
the screen modeler configured to emulate the operation of the selected control displayed on the prototyping display screen of the development user computing device platform as the operation of the selected control would operate and be displayed on the selected end user computing device platform.

14. The system of claim 12 further comprising:
the screen modeler configured to emulate the operation of the selected control displayed on the prototyping display screen of the development user computing device platform as the operation of the selected control would operate and be displayed on the selected end user computing device platform through accessing at least one of the selected list of data sources.

15. The system of claim 13 wherein the selected list of controls includes at least a textbox control, a drop-down-list control and a button control.

16. The system of claim 14 wherein the selected list of data sources includes at least one of a database, a web-service and a rich site summary (“RSS”).

17. The system claim 10 wherein the model screen display specific to the selected end user computing device platform, displayed during design time, comprises a WYSIWYG representation of a corresponding screen display on the selected end user computing device platform at runtime.

18. The system of claim 1 wherein the selected end user computing device platform comprises a mobile computing device platform.

19. A machine readable medium storing instructions that, when executed by a computing device cause the computing device to perform a method comprising:
modeling a screen display specific to the selected end user computing device platform, utilizing a development user computing device platform, by selecting an object for at least one of a user interface display or a control of a functionality of the application running on the selected user computing device platform, at run time, utilizing a prototyping display screen modeler during design time;
wherein the prototyping display screen modeler, during design time, is one of operating on the development user computing device platform or being accessed over a network by the development user computing device platform; and
constructing the model screen display specific to the selected end user computing device platform during design time, utilizing a user interface display on the development user device platform of at least one of a selection of controls and a selection of data sources displayed on the user interface display of the development user device.

20. The machine readable medium of claim 19 wherein the model screen display specific to the selected end user computing device platform, displayed during design time, comprises a WYSIWYG representation of a corresponding screen display on the selected end user computing device platform at runtime.
